(19) United States
(12) Patent Application Publication
(10) Pub. No.: US 2026/0327122 A1
(43) Pub. Date: Oct. 22, 2026

(54) METHOD AND SYSTEM FOR PROCESSING WASTE MATERIAL

(71) Applicant: ONUNDA LIMITED, Carlisle Cumbria (GB)

(72) Inventor: James MEYER, Carlisle Cumbria (GB)

(21) Appl. No.: 19/104,771

(22) PCT Filed: Aug. 18, 2023
(86) PCT No.: PCT/EP2023/072874

§ 371 Date: Feb. 19, 2025

(30) Foreign Application Priority Data
Aug. 19, 2022 (GB) 2212142.0

(51) Int. Cl. C02F 11/13; C02F 11/10; C02F 103/00

(52) U.S. Cl. CPC C02F 11/13; C02F 11/10; C02F 2103/005; C02F 2201/004; C02F 2201/007; C02F 2201/009; C02F 2209/02; C02F 2209/03; C02F 2209/38; C02F 2209/44

(57) ABSTRACT

A method of processing waste material, wherein the waste material includes human and/or animal digestive waste and/or plant derived waste is provided. The method includes: receiving an input of waste material into a reactor pressure vessel. heating and pressuring the reactor pressure vessel to perform a hydrothermal carbonization process of the waste material separating a portion of the liquid from solid components of the products produced through the hydrothermal carbonization process. performing a gasification and/or pyrolysis process on the solid components, to produce syngas and/or pyrolysis gas. A system for performing the method is also provided.

### TECHNICAL FIELD

The present disclosure relates to a method and system for processing waste material.

### BACKGROUND

In the UK, the unintentional release of untreated sewage into lakes, rivers and seas via Combined Storm Overflows (CSO's) is a serious problem, causing pollution which is hugely detrimental to the environment and public. This problem will be worsened by population growth and rapid urbanisation which will increase the amount of sewage sludge generated. The sustainable and efficient disposal of sludge is an absolute necessity for a resilient, robust and sustainable society, especially those that aspire to a circular economy.

In industrialised societies sewage waste is treated in wastewater treatment plants. Some of the solid portion of the waste is collected as it arrives in the treatment plant, which is called primary sludge. The remainder, which constitutes the bulk of the sludge, is “in essence” fed to bacteria. The bacteria consume the waste so efficiently that as much as 80% of the waste is converted to biomass (secondary sludge) which must also be disposed of. Overall, the disposal of primary and secondary sludge can account for 60% of the operating costs of a wastewater treatment plant.

Sewage waste is also a significant issue in remote areas not connected to modern sewage infrastructure. In rural parts of industrialised countries or urban areas in lower-and middle-income countries (LMIC), on site sanitation systems (OSS) are preferred. In OSS faecal sludge is stored locally and must be collected and disposed of which is problematic and costly. The disposal of such sludges is complicated as on one hand they are a resource, rich in energy, nitrogen and phosphorous. On the other hand, they are a pollutant, containing potent oxygen depleting carbon sources, greenhouse gasses (nitrous oxide and methane), eutrophication inducing nutrients (nitrogen and phosphorous) and pathogens as well as a diverse range of micropollutants including plastic, endocrine disrupting compounds, antimicrobial resistance genes and heavy metals. However, water is the most troublesome component. Raw sludges are 97-99% water, though they can be thickened to 90-95% water or actively dewatered to 15-40% solids.

The water industry has developed successful and sophisticated strategies for the disposal of biosolids which is the UK industry term for both primary and secondary sludges. They are typically treated in anaerobic digesters (AD) to recover energy and reduce biomass volumes. The resulting sludge is typically disposed of and the liquor must be treated. At present the UK produces about 8,500 tonnes of sludge a day of which 87% goes to land which is not a resilient and sustainable solution.

Although the energy produced by AD is a welcome contribution to our net zero targets and some of the phosphorous may be captured by chemical precipitation, the availability of land for sludge disposal (the land bank) is an ongoing cause for concern for the industry. Concerns about emerging contaminants and Environment Agency regulation to control river pollution may limit land disposal. Therefore, innovative technological solutions must be developed urgently. The success of such solutions will have great impacts on public health and the environment.

### Statements of Invention

According to an aspect of the present disclosure, there is provided a method of processing waste material, wherein the waste material comprises human and/or animal digestive waste and/or plant derived waste, e.g. that may or may not have undergone a process, e.g. pre-treatment with a biological process, of anaerobic and/or aerobic digestion and/or a pre-treatment process with anaerobic and/or aerobic and/or anoxic bacteria. The method comprises: receiving an input of waste material into a reactor pressure vessel; heating and pressurising the reactor pressure vessel to perform a hydrothermal carbonization process, of the waste material; separating at least a portion of a liquid from solid components (wet hydrochar) of the products produced through the hydrothermal carbonization process; performing a pyrolysis and/or gasification process, e.g. a thermal gasification process, on the solid components, e.g. remaining solid components, to produce syngas, and optionally pyrolysis gas, e.g. volatile hydrocarbons and/or organic compounds, e.g. respectively.

Positioning hydrothermal carbonisation technology upstream of thermal gasification technology is beneficial when treating biosolids, biomass, and organic materials. This is because hydrothermal carbonisation removes the nitrogen-containing compounds and increases the C/O and C/H ratios of the hydrochar for subsequent gasification and production of low NOx, high-calorific value syngas.

The positioning of hydrothermal carbonisation technology and thermal gasification technology in this manner also eliminates microplastics, per-and polyfluoroalkyl substances and antibiotics as any of the unhydrolyzed chemicals are retained in the solid hydrochar fraction which is subsequently gasified and converted into usable syngas and high-ash carbon residue. Furthermore, generation and capture of the thermal and electrical energy from combustion of the high calorific-value syngas can be used to supply the thermal and electrical energy needs of both technologies.

By linking these two technologies, integrating the generated thermal and electrical energy and waste heat, and including principles of process intensification in the design of the hydrothermal carbonisation reactors and expansion vessels, an innovative technical solution has been developed to address and deal with the problem of contaminated sludge disposal to land banks.

The method may comprise drying the separated solid components (wet hydrochar) to a target moisture content. The wet hydrochar may be dried with a direct rotary dryer. The wet hydrochar may be dried using waste heat, e.g. recovered, from the hydrothermal carbonisation step. Waste heat in the form of hot combustion gas may be diverted to convectively dry the wet hydrochar from a starting solids content of between 40 and 70% to a final solids content of at least 90% (by mass). The waste heat may be fed either co-currently or counter-currently to the direct rotary dryer.

The waste material may comprise a digestate sludge, e.g. produced through anaerobic and/or aerobic digestion of human and/or animal digestive waste and/or plant derived waste. The digestate sludge may be treated with a flocculant or coagulant.

The reactor pressure vessel may be heated to a reaction temperature greater than 160 degrees Celsius, such as between 160 and 260 degrees Celsius, or greater than 180 degrees Celsius, for example 200 degrees Celsius, to perform the hydrothermal carbonization process. The reactor pressure vessel may be heated at a rate of between 2 and 5 degrees Celsius per minute for 60 to 90 minutes to reach the reaction temperature. The reactor pressure vessel may be maintained at the reaction temperature for between 30 minutes and 240 minutes, or between 30 minutes and 60 minutes. In one example, the reactor pressure vessel may be maintained at the reaction temperature for approximately 4 hours. Reaction temperature and pressure of the reactants within the reactor pressure vessel may be maintained to achieve subcritical conditions for water within the reactor pressure vessel, e.g. so that the water behaves as a subcritical fluid. The reaction temperature and pressure of the reactants within the reactor pressure vessel maybe configured to reduce a dielectric constant of water within the reactor pressure vessel, so it becomes similar to the dielectric constants of nitrogen and phosphorous containing compounds. For example, the reaction temperature and pressure of the reactants within the reactor pressure vessel maybe configured to reduce a dielectric constant of water within the reactor pressure vessel to less than 40, such as between 20 and 30, e.g. between 20 and 25.

The operating temperature of the high pressure reaction vessels may be selected based on the desired outcome of the method. The outcome may be one or more of: (i.) higher hydrochar yield, (ii.) higher nutrient recovery, (iii.) a particular distribution of heavy metals between the solid and aqueous phases, or any other desirable outcome. The hydrothermal carbonization process may be performed as a continuous series of batch operation processes, performed using a plurality of the reactor pressure vessels configured to receive the waste material sequentially and perform the hydrothermal carbonization process at time periods offset from one another by less than a total duration of the hydrothermal carbonization process.

The method may further comprise discharging the products of the hydrothermal carbonization process to an expansion vessel at a lower pressure than the reactor pressure vessel. For example, prior to the step of separating the liquid from the solid components and/or or prior to the step of drying the wet hydrochar. In some arrangements, the method may comprise discharging the products of the hydrothermal carbonization process to two or more expansion vessel in parallel, the two or more expansion vessels at a lower pressure than the reactor pressure vessel.

The method may comprise circulating gases from the expansion vessel through a gas heat exchanger configured to transfer heat from the expansion vessel gases to the input waste material, e.g. prior to the waste material being received in the reactor pressure vessel. Additionally or alternatively, the method may comprise circulating the separated liquid through a liquid heat exchanger configured to transfer heat from the separated liquid to the input waste material, e.g. prior to the waste material being received in the reactor pressure vessel. The gas heat exchanger may be arranged downstream of the liquid heat exchanger, relative to the passage of the input waste material to the reactor pressure vessel.

The liquid may be separated from the solid components through a physical separation process. For example, the liquid may be separated from the solid component using a filter press or a solids/liquids centrifuge. The separated liquid may be output as a fertiliser, e.g. a fast nutrient-release liquid fertiliser, and/or may fed to an anaerobic digestor to produce biogas and/or to reduce the carbonaceous oxygen demand of the process water before being discharged, e.g. to the environment. The separated liquid may also be further processed and/or mixed with carbon residue, e.g. high-ash carbon residue, produced by the method, e.g. depending on the composition of the carbon residue produced.

The method may further comprise combusting the syngas, and optionally pyrolysis gas, e.g. volatile hydrocarbons and organic compounds, produced though the gasification process in a gas generator to generate electricity. The electricity generated by the gas generators may be used to power a heater for the reactor pressure vessel, e.g. during steady state performance of the method. The method may comprise providing electricity from a source separate from the gas generator to heat the reactor pressure vessel during a start-up procedure. Optionally, the electricity generated by the gas generators may be used to power other electrical equipment at a plant in which the method is performed.

The method may further comprise delivering a portion of the produced syngas as an input to the gasification process. The portion of the produced syngas may be combusted in order to heat the reactants of the gasification process. The method may further comprise providing combustible gas from a source separate from the gasification reactor, such as natural gas and/or propane and/or liquified petroleum gas (LPN) and/or liquified natural gas (LNG), as an input to the gasification process, e.g. during a start-up procedure of the method of processing waste material. The combustible gas may be combusted in order to heat the reactants of the gasification process during the start-up procedure for the method of processing waste material. The combustible gas may no longer be provided as an input to the gasification process once the syngas is available to be combusted for heating the reactants.

The method may comprise circulating combustion gases, e.g. from the gas generator, gasifier, ground flare or a burner, around the reactor pressure vessel to heat the reactor pressure vessel and perform the hydrothermal carbonisation process. The combustion gases fed over the separated solids may be combustion gases that have been circulated around the reactor pressure vessel.

The method may further comprise circulating the combustion gases resulting from the combustion for heating the reactants of the gasification process to heat the input waste material upstream and/or within the reactor pressure vessel. During steady state operation, the hydrothermal carbonization high pressure reactors may be heated using, e.g. exclusively using, waste heat (combustion gas) from the gasification step. The or each reactor pressure vessel may comprise a heating jacket and the combustion gas may be diverted from the thermal gasifier, e.g. from the thermal gasifier shroud exhaust, to pass through the heating jacket. Thermal energy is transferred from the hot combustion gas to the reactor pressure vessel to heat its contents to the desired operating temperature. During start-up, a natural gas/propane burner may be used to heat the reactor pressure vessels by passing hot combustion gas through the heating jacket to heat its contents to the desired operating temperature. The method may further comprise cleaning the syngas produced through the gasification process prior to the syngas being used for other purposed as part of the method of processing waste, in order to remove contaminants from the syngas.

The method may further comprise providing a further input of comminuted, optionally non-biodegradable, waste to the gasification process.

The method may further comprise recirculating at least a portion of the contaminants, such as tar and/or oil, removed from the syngas as an input to the gasification process. According to another aspect of the present disclosure, a system for processing waste material, wherein the waste material comprises human and/or animal digestive waste and/or plant derived waste, e.g. that may or may not have undergone a process, e.g. pre-treatment with a biological process, e.g. of anaerobic and/or aerobic digestion and/or a pre-treatment process with anaerobic and/or aerobic and/or anoxic bacteria. The system comprises: a reactor pressure vessel assembly comprising one or more reactor pressure vessels for receiving an input of waste material and heating and pressurising the waste material within the vessels to perform a hydrothermal carbonization process of the waste material; a separating unit, for separating liquid from solid components produced though the hydrothermal carbonization process; a gasification reactor vessel for receiving the solid components and performing a gasification and/or pyrolysis process on the separated solids within the gasification reactor vessel to produce syngas and/or pyrolysis gas, e.g. respectively.

The reactor pressure vessel assembly may further comprise one or more expansion vessels for receiving the products of the hydrothermal carbonization process, known as hydrochar slurry, from the one or more reactor pressure vessels at a lower pressure than the reactor pressure vessels.

The system may further comprise a gas heat exchanger configured to receive gases from the one or more expansion vessels and transfer heat from the gases to the input waste material. The gases received from the one or more expansion vessels may comprise, e.g. predominantly comprise, steam. The system may further comprise a liquid heat exchanger, configured to receive the liquid separated by the separating unit, which may be known as nutrient-rich process water, and transfer heat from the liquid to the input waste material. The gas heat exchanger may be arranged downstream of the liquid heat exchanger, relative to the passage of the input waste material to the reactor pressure vessel assembly, e.g. through the heat exchangers.

The system may further comprise a direct rotary dryer for removing moisture from the wet hydrochar (separated solid components). The direct rotary dryer may be for removing moisture by convective drying using waste heat from the hydrothermal carbonisation process.

The system may further comprise a gas generator for using the syngas produced by the gasification reactor to produce electricity. The reactor pressure vessel assembly may comprise one or more electric heaters, for heating the reactants within the reactor pressure vessels. The electric heaters may be electrically connected to the gas generator. Additionally or alternatively, the reactor pressure vessel assembly may comprise one or more jackets arranged about the reactor pressure vessels, e.g. respectively. The jackets may be configured to received heated gases, such as combustion gases from natural gas/propane burners and/or the gasification reactor vessel and heat the reactants within the reactor pressure vessels.

The system may further comprise a syngas cleaning unit for removing contaminants, such as acid gas, tar, and/or oil and/or entrained solids from the syngas produced in the gasification reactor vessel. The syngas cleaning unit may be provided between the gasification reactor vessel and the gas generator (and/or the ground flare when provided) relative to the flow of syngas. The syngas cleaning unit may comprise a wetted wall scrubber. The wetted wall scrubber may comprise a plurality of spray nozzles for spraying water in order to increasing the contact surface area between the syngas and the water. The syngas cleaning unit may further comprise one or more baffles configured to promote turbulent flow of the gas passing through the cleaning unit. In some arrangements, the Syngas cleaning unit may comprise a cyclone for removing entrained solids and/or a dry scrubber system and/or an aqueous scrubber system, such as a venturi quench, cyclonic scrubber and/or packed-bed scrubber, for removing aerosol tars and/or oils, and acid gases present in the syngas. The Syngas Cleanup unit may also include a condenser configured to remove water from the saturated syngas prior to combustion in the gas generator. The system may further comprise a contaminant recirculation duct for recirculating at least a portion of the contaminants, such as tar, removed from the syngas to the gasification reactor.

The gasification reactor may comprise one or more burners for burning a gas to heat reactants in the gasification process. The system may comprise a syngas supply duct, for supplying syngas output by the gasification reactor to the one or more burners, e.g. from downstream of the syngas cleaning unit. The burners may be further configured for burning natural gas/propane/LPG/LNG to heat the reactants in the gasification reactor, e.g. when insufficient syngas is available to heat the gasification reactor, e.g. during start-up of the system.

The reactor pressure vessel assembly may comprise a plurality of reactor pressure vessels and one or more expansion vessels. The reactor pressure vessels may be configured to store reactants and products at a higher pressure than the expansion vessels, The expansion vessels may be configured to receive products of the reaction within the respective reactor pressure vessels.

The reactor pressure vessel assembly may be configured to operate in a continuous series of batch procedures in which reactants are input to the plurality of reactor pressure vessels sequentially. Products of the reactions within the reactor pressure vessels may be output to expansion vessels sequentially. The hydrothermal carbonization procedure may be conducted over staggered time periods within the sequential reactor pressure vessels.

The reactor pressure vessel assembly may further comprise one or more ducts for conducting gases from the expansion vessels to one or more heat exchangers for heating reactants input to respective ones of the reactor pressure vessels. The ducts may be arranged so that that gases from the expansion vessels are conducted to the heat exchanger configured to heat the reactant within the next of the reactor pressure vessels to receive reactants in the continuous series of batch procedures.

The system may comprise a combustion gas duct, for conducting combustion gases from the gasification reactor to the reactor pressure vessel assembly. The system may further comprise one or more combustion gas heat exchangers, e.g. combustion gas heating jackets, for transferring heat from the combustion gases to the waste material input to the reactor pressure vessel assembly.

According to another aspect of the present disclosure, there is provided a reactor pressure vessel assembly comprising a plurality of reactor pressure vessels and one or more, e.g. a single or a corresponding number of, expansion vessels, wherein the reactor pressure vessels are configured to store reactants and products at a higher pressure than the expansion vessels, optionally wherein each of the expansion vessels is associated with a different one of the reactor pressure vessels, wherein the expansion vessels are configured to receive products of the reaction within the reactor pressure vessels, e.g. respect reactor pressure vessel.

The reactor pressure vessel assembly may further comprise one or more ducts for conducting gases from the expansion vessels to one or more heat exchangers for heating reactants being input to or within respective ones of the reactor pressure vessels.

The reactor pressure vessel assembly may be configured to operate in a continuous series of batch procedure in which reactants are input to the plurality of reactor pressure vessels sequentially, products of the reactions within the reactor pressure vessels are output to the expansion vessels sequentially, and the hydrothermal carbonization procedure is conducted over staggered time periods within the sequential reactor pressure vessels.

The ducts may be arranged so that that gases from the expansion vessels are conducted to the heat exchanger configured to heat the reactant within the next of the reactor pressure vessels to receive reactants in the continuous series of batch procedures.

Each of the reactor pressure vessels may be associated with a heater, e.g. an electric heater, for heating the reactants within the reactor pressure vessel. Each of the reactor pressure vessels may be associated with a heat exchanger, e.g. a heating jacket, for receiving combustion gases and transferring heat from combustion gases to the reactants within the corresponding reactor pressure vessel.

The system may further comprise a dryer, such as a direct rotary kiln, for dying the separated solid components to a target moisture content, e.g. using a convective drying process.

The system may comprise a ground flare unit configured to receive the syngas, e.g. from the syngas cleaning unit, and burn the syngas to produce combustion gas for heating the reactor pressure vessel and/or to be fed to the dryer for drying the separated solid components, e.g. during a start-up procedure of the system.

The system may comprise an electrical generator combustion gas duct configured to conduct combustion gases from the gas generator to the reactor pressure vessel assembly for heating the reactor pressure vessel assembly, e.g. during a steady-state operation of the system.

The system may comprise one or more burners for supplying hot combustion gases to heat the reactor pressure vessel assembly, e.g. during a start-up procedure of the system.

To avoid unnecessary duplication of effort and repetition of text in the specification, certain features are described in relation to only one or several aspects or embodiments of the invention. However, it is to be understood that, where it is technically possible, features described in relation to any aspect or embodiment of the invention may also be used with any other aspect or embodiment of the invention. For example, features described in relation to the first mentioned aspect may be combined with the features of the second mentioned aspect.

### BRIEF DESCRIPTION OF THE DRAWINGS

For a better understanding of the present invention, and to show more clearly how it may be carried into effect, reference will now be made, by way of example, to the accompanying drawings, in which:

FIG. 1 is a schematic diagram of a system for processing a waste material comprising biosolids, such as human and/or animal digestive waste and/or plant derived waste that may or may not have gone through anaerobic and/or aerobic digestion, according to an arrangement of the present invention;

FIG. 2 is a flow diagram depicting a method for processing a waste material comprising biosolids, such as human and/or animal digestive waste and/or plant derived waste that mayor may not have gone through anaerobic and/or aerobic digestion, according to an arrangement of the present invention;

FIG. 3 is a schematic diagram of another system for processing a waste material comprising biosolids, such as human and/or animal digestive waste and/or plant derived waste that may or may not have gone through anaerobic and/or aerobic digestion, according to an arrangement of the present invention; and

FIG. 4 is a flow diagram depicting another method for processing a waste material comprising biosolids, such as human and/or animal digestive waste and/or plant derived waste that may or may not have gone through anaerobic and/or aerobic digestion, according to an arrangement of the present invention.

### DETAILED DESCRIPTION

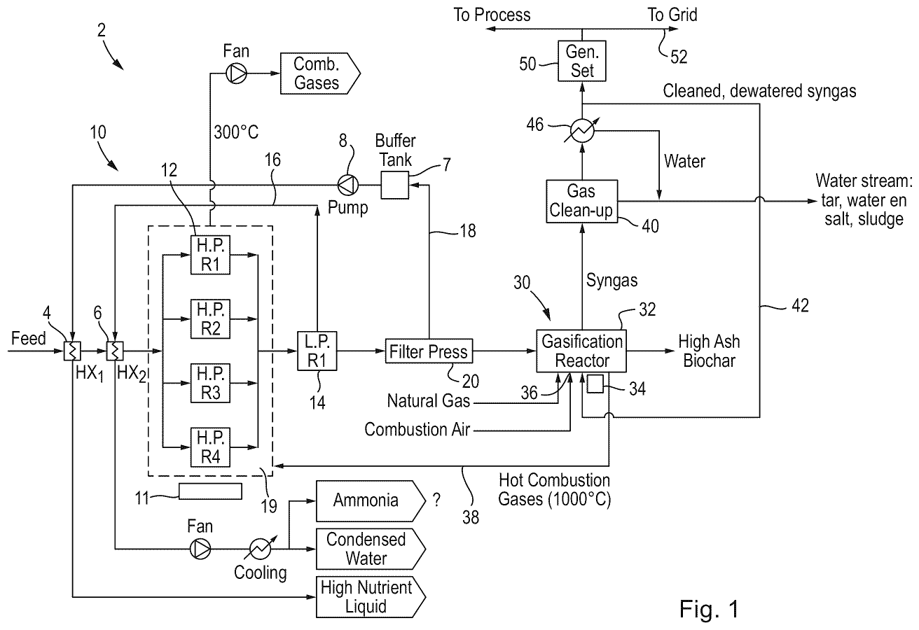

With reference to FIG. 1, a system 2 for processing waste material, will now be described. The system may be for processing waste material comprising biomass and/or biosolids. For example, human and/or animal digestive waste and/or plant derived waste that may or may not have gone through anaerobic and/or aerobic digestion. As mentioned above, biosolids may refer to primary sludge, and/or secondary sludge, and/or mixed sludge, and/or digestate sludge, and/or activated sludge that has been thickened and/or dewatered to 5-40% solids concentration. The system comprises a reactor pressure vessel assembly 10, comprising one or more reactor pressure vessels 12, which may also be referred to within the present specification as high pressure reaction vessels. The system 2 further comprises a separating unit 20 and a gasification reactor assembly 30.

The reactor pressure vessel assembly 10 comprises an input for receiving waste material, e.g. biosolids and/or biomass. For example, primary sludge, and/or secondary sludge, and/or mixed sludge, and/or digestate sludge, and/or activated sludge that has been thickened and/or dewatered to 5-40% solids concentration comprising the metabolites of aerobic or anaerobic digestion of human, animal, and/or plant waste. It may also comprise both dead and live bacteria. The sludge provided at the input may be produced through a sludge concentration process, in which a water concentration of the sludge has been brought, e.g. reduced, to approximately 5-40% solids. Accordingly, the sludge input to the reactor pressure vessel assembly 10 may comprise approximately 10-20% solids, e.g. biomass containing solids, and approximately 80-90% liquid, e.g. water. In some arrangements, the biosolids may comprise a flocculant or coagulant. The digestate sludge input the reactor pressure vessel assembly 10 may be received within one or more of the one or more reactor pressure vessels 12.

The reactor pressure vessel assembly 10, may be configured to heat and pressurise the sludge within the reactor pressure vessels 12 in order to perform a hydrothermal carbonization process.

When organic materials such as biosolids and biomass are exposed to the subcritical conditions of hydrothermal carbonisation, they begin to hydrolyse which removes (cleaves) oxygen-containing compounds, nitrogen-containing compounds, and phosphorous-containing compounds from the solid material. Furthermore, the nitrogen-containing compounds are converted to ammonium under neutral and slightly basic pH conditions, and the phosphorous-containing compounds are converted to phosphate ions.

The objectives of the hydrothermal carbonisation process may be one or more of (i.) chemically dehydrate the organic solids in the feedstock to increase the carbon to oxygen and/or carbon to hydrogen ratios of the solid components of the sludge (hydrochar), (ii.) recover nitrogen and phosphorous containing compounds by ‘cleaving’ them from the organic solids in the feedstock and solubilising them in the aqueous phase of the hydrochar slurry, (iii.) hydrolyse microplastics, per-polyfluoroalkyl substances, and antibiotics into their respective harmless, soluble byproducts, (iv.) kill bacteria/microorganisms present in the feedstock by exposure to high temperatures and pressures, (v.) rupture/lyse animal and plant cells present in the feedstock to spill the intracellular fluid into the hydrochar slurry, and/or (vi.) separate a portion of the water present in the hydrochar slurry by producing steam through pressure throttling.

During the hydrothermal carbonization process, the solid, e.g. biosolids and/or biomass containing, components of the sludge may be converted into carbon containing molecules more suitable for use as reactants, e.g. suitable to be pyrolyzed and/or gasified, in a pyrolysis and/or gasification process, e.g. respectively, as described below. More particularly, to perform the hydrothermal carbonization process, the sludge may be heated to a reaction temperature greater than 160 degrees Celsius, greater than 170 degrees Celsius or greater than 180 degrees Celsius, such as between 160 and 260 degrees Celsius. For example, the sludge may be heating to approximately 200 degrees Celsius, and may reach a reaction pressure of greater than 0.6 MPa, greater than 1.5 MPa, or greater than or equal to 2MPa, such as between 0.6 and 4.7 MPa or between 2 and 2.5 MPa. The reactor pressure vessel may be heated at a rate of between 2 and 5 degrees Celsius per minute for 60 to 90 minutes to reach the reaction temperature. The sludge may be maintained at the reaction temperature and pressure for between 30 minutes and 240 minutes, or between 30 minutes and 60 minutes. In one example, the reactor pressure vessel may be maintained at the reaction temperature for longer than 3 hours, such as approximately 4 hours, or longer than 4 hours.

The operating temperature of the high pressure reaction vessels may be selected based on the desired outcome. The outcome may be one or more of: (i.) higher hydrochar yield, (ii.) higher nutrient recovery, (iii.) a particular distribution of heavy metals between the solid and aqueous phases, or any other desirable outcome.

The reactor pressure vessel assembly 10 may comprise a plurality of reactor pressure vessels 12. In the arrangement depicted in FIG. 1, the reactor pressure vessel assembly 10 comprises four reactor pressure vessels 12. However, in other arrangements, the reactor pressure vessel assembly 10 may comprise any other number of reactor pressure vessels, such as between two and four pressure vessels. The reactor pressure vessel assembly 10 may be configured to perform the hydrothermal carbonization process of the sludge in a series of batch operating modes resembling that of a continuous process. For example, processing, e.g. heating and pressurising, of the sludge within each of the reactor pressure vessels may be staggered by a period of time less than the total duration for which the sludge is process in the reactor pressure vessels. For example, heating of the sludge within each of the pressure vessels may begin between approximately 1 and 2 hours after heating of the sludge within a another of the pressure vessels began.

During a start-up procedure of the system, each of the reactor pressure vessels 12 may be filled with the input biosolids and/or biomass. However, it will be appreciated that due to the staggered initiation of the process in each reactor pressure vessel, the completion time of the process in each of the reactor pressure vessels 12 will be staggered and filling of the reactor pressure vessels for future batches, e.g. during steady state operation of the system, can also be staggered, e.g. so that the reactor pressure vessels are filled sequentially.

The reactor pressure vessel assembly 10 may comprise a one or more heaters 11 for heating the waste material within the reactor pressure vessels, e.g. the reactants of the hydrothermal carbonization process. For example, the reactor pressure vessel assembly 10 may comprise a heater 11 associated with each respective reactor pressure vessel 12. The heaters may be electrical heaters. During the start-up procedure of the system 2, electrical power may be supplied to one or more of the heaters from an electrical source external to the system, such as an electrical supply grid, in order to heat the reactor pressure vessels 12 to the reaction temperature. However, as described below, during steady state operation of the system 2, electrical power may be generated within the system 2 for powering the one or more heaters 11. At the reaction temperature and pressure, a dielectric coefficient of the water within the sludge may be reduced, so it becomes similar to the dielectric constants of nitrogen and phosphorous containing compounds, e.g. which may be present within the input feedstock or hydrochar slurry. For example, the reaction temperature and pressure of the reactants within the reactor pressure vessel maybe configured to reduce a dielectric constant of water within the reactor pressure vessel to less than 40 or less than 30, such as between 20 and 30 or between 20 and 25. This allows the dissolution of these ionic constituents away from the hydrochar solid and into the aqueous phase. Furthermore, microplastics, per-and polyfluoroalkyl substances, and antimicrobial resistant genes are hydrolysed into their respective harmless, soluble constituents under the subcritical conditions of hydrothermal carbonisation. Accordingly, a solubility/miscibility of macronutrient substances, such as nitrogen and/or nitrogen containing compounds in the water may be increased compared to at atmospheric temperatures and pressures. Further, the hydrothermal carbonization process may lead to nitrogen and/or nitrogen containing components being released from the solid components of the sludge. Accordingly, the conditions of the hydrothermal carbonization process may lead to nitrogen and nitrogen containing compounds, such as ammonium, within the sludge being dissolved in the water, optionally after having been released from the solids. Further, the removal of oxygen-containing compounds increases the C/O (carbon to oxygen) and C/H (carbon to hydrogen) ratios of the hydrochar solid which significantly improves the calorific value of the pyrolysis gas or syngas when pyrolyzed or thermally gasified respectively.

In some arrangements, a reactive, e.g. nucleophilic, substance such as an organic acid and/or calcium oxide, may be added to the reactor pressure vessel during the hydrothermal carbonization process, in order to promote the hydrolysis reactions, e.g. the release of ammonium. The released ammonium may then become dissolved within the water.

In addition to facilitating nitrogen and nitrogen containing compounds being dissolved in the water and optionally release from the solids of the sludge, the carbonization reaction conditions may similarly lead to the release of other organic and/or inorganic substances, e.g. macronutrient substances, such as phosphorous, potassium (and phosphorous and potation containing compounds) from the solids and/or the dissolving of such substances in the water.

The reactor pressure vessel assembly 10 may comprise one or more expander vessels 14. The products from the hydrothermal carbonization process, e.g. hydrochar slurry, may be output from the reactor pressure vessels 12 into the one or more expander vessels 14 at a lower pressure than within the reactor pressure vessels. The products of the hydrothermal carbonization process may comprise between 10% and 20% solids. The hydrochar slurry may be discharged from the reactor pressure vessels under the action of gravity into the expander vessels. For example, the pressure within the expander vessels may be approximately atmospheric. The reduction in pressure, e.g. rapid reduction in pressure, of the hydrothermal carbonization products within the one or more expander vessels may lead to rupturing of the structure of the solid components of the products, which may in turn release further amounts of nitrogen, phosphorous, potassium (and nitrogen, phosphorous and potassium containing compounds) and organic substances from the solids, e.g. into the liquid of the products. Additionally, discharging the products of the hydrothermal carbonization process into the expansion vessels 14 may cause any bacteria, e.g. pathogenic bacteria and/or microorganisms, present in the products to rupture. The products of the hydrothermal carbonization process within the expansion vessel may therefore be sterile. Additionally again, discharging the products to the expansion vessel 14 may cause up to 20% (by mass) of water in the hydrochar slurry to converted, e.g. substantially instantaneously, to steam.

In the arrangement shown in FIG. 1, the reactor pressure vessel assembly 10 comprises a single expansion vessel 14 configured to receive the hydrothermal carbonization products from each of the reactor pressure vessels 12. However, in other arrangements, any other number of expansion vessels 14 may be provided. For example, a number of expansion vessels 14 may be provided corresponding to a number of reactor pressure vessels 12. In such arrangements, the expansion vessels may be associated with, e.g. configured to receive the products from, one or more, e.g. respective ones of the reactor pressure vessels 12. In one or more arrangements, two expansion vessels 14 may be provided, e.g. in total or for each reactor pressure vessel 12.

The system 2 may further comprise a gas heat exchanger/steam condenser 4. The gas heat exchanger/steam condenser 4 may be configured to receive gases from the expansion vessels 14, such as steam, and transfer heat from the gases to the waste material to be input to the reactor pressure vessel assembly 10. The system 2 may comprise one or more ducts 16 for conducting gases, such as water vapour, from the expansion vessels 14 to the gas heat exchanger 4.

The separation unit 20 may be provided downstream of the reactor pressure vessel assembly 10. The separation unit 20 may be arranged to receive the products of the hydrothermal carbonization process. For example, the separation unit 20 may be arranged to receive the products of the hydrothermal carbonization process from the reactor pressure vessels 12 or the expansion vessels 14 (if present). In some arrangements, the system 2 may comprise a slurry pump configured to transfer the hydrochar slurry at from the expansion vessel 14 to a buffer/holding vessel (not shown) positioned upstream of the separation unit 20 from which the slurry may be fed to the separation unit. The buffer/holding vessel may be thermally insulated. The hydrochar slurry may then be fed from the buffer/holding vessel to the separation unit at a temperature of 20-80 °C.

After the products of the hydrothermal carbonization reaction have been output from the reactor pressure vessels 12 and/or the expansion vessels 14, a short spray of high pressure municipal water may be provided into the vessels to wash away any remaining hydrochar solids and help minimise fouling of these vessels.

The separation unit 20 may be configured to separate at least a portion of the liquid present in the products of the hydrothermal carbonization process from the solid components. For example, the separation unit 20 may be configured to separate at least a portion of the water present in the products together with any substances dissolved in the water. The separated solid components may be referred to as wet hydrochar.

The separation unit 20 may be configured to separate the liquid from the solid components through a physical separation process, such as a physical dewatering process. For example, the separation unit 20 may comprise a filter press. Alternatively, the separation unit 20 may comprise any other device suitable for separating at least a portion of the liquid, e.g. water, present in the hydrothermal carbonization products from the solid components, such as a solids/liquids centrifuge. When the separation unit comprises a filter press, the hydrochar slurry may be pumped to a pressure of 4-17 bar absolute. The filter press may be operated in a fed batch or continuous mode. The output from the separation unit may comprise 40 to 70% solids.

The system 2 may comprise a liquid heat exchanger 6. The liquid heat exchanger 6 may be configured to receive the liquid separated by the separation unit and transfer heat from the liquid to the waste material to be input to the reactor pressure vessel assembly 10. The liquid heat exchanger 6 may be arranged upstream of the heat exchanger 4 relative to the flow of waste material through the heat exchanger 4 and the liquid heat exchanger 6. In some arrangements, the system 2 may comprise a buffer tank 7, which may be heat insulated. The buffer tank 7 may be configured to store the liquid separated by the separation unit 20 until required to heat the waste material being input to the reactor pressure vessel, e.g. when a next batch of sludge is input to one or more of the reactor pressure vessels 12. The system 2 may further comprise a pump 8 for pumping the liquid from the separator unit 20 and/or buffer tank 7 to the liquid heat exchanger 6.

The system 2 may further comprise one or more liquid ducts 18, for carrying the liquid separated by the separation unit 20 to the liquid heat exchanger, e.g. via the buffer tank 7 and/or pump 8.

As described above, one or more substances, e.g. macronutrient substances, such as nitrogen, potassium, phosphorus, nitrogen containing compounds, potassium containing compounds, phosphorus containing compounds, and organic compounds, e.g. soluble organic compounds, may be dissolved or mixed with the liquid products of the hydrothermal carbonization process. Such substances may be undesirable to include as reactants in a gasification process for producing syngas, as described below. Hence, by separating at least a portion of the liquid from the solid components of the hydrothermal carbonization products, the concentration of such substances may be reduced in the solid phase products.

The liquid separated from the products of the hydrothermal carbonization process may be stored for use in another method. For example, the stored liquid may be used in a process for producing a fertiliser, e.g. a fast nutrient-release liquid fertiliser, and/or may fed to an anaerobic digestor to produce biogas and/or to reduce the carbonaceous oxygen demand of the process water before being discharged, e.g. to the environment. The separated liquid may also be further processed and/or mixed with carbon residue, e.g. high-ash carbon residue, produced by the gasification reactor, e.g. depending on the composition of the carbon residue produced. The liquid separation from the products of the hydrothermal carbonization process may be referred to as nutrient rich process water.

The gasification reactor assembly 30 comprises a gasification reactor vessel 32 arranged to receive the solid components separated from the products of the hydrothermal carbonization process and remaining liquid that was not separated. The gasification reactor assembly 30 is configured to perform a pyrolysis and/or gasification process, e.g. a thermal gasification process, on the solid components within the gasification reactor to produce syngas and/or pyrolysis gas, e.g. respectively. In other words, the gasification and/or pyrolysis process may produce a mixture of syngas and hydrocarbons, e.g. volatile hydrocarbons. Features described herein with reference to gasification may also apply to pyrolysis and vice versa. Similarly, features described herein with reference to syngas may also apply to pyrolysis gas and vice versa. The solid components separated from the products of the carbonisation process and remaining water may form the reactants for the gasification process within the gasification reactor.

Hydrochar, preferably containing at least 90% solids (by mass) may be buffered and/or metered and/or fed to the gasification reactor on a continuous basis. During the gasification process, the water present in the reactants may be superheated to steam and may react with carbon containing substances within the solid components. More particularly, the water may react with solid carbon to produce hydrogen and carbon monoxide in a water gas reaction, the water may react with carbon monoxide to form hydrogen and carbon dioxide in a water gas shift reaction and the water may react with hydrocarbons to produce carbon monoxide and hydrogen in a steam reformation reaction. Other side reaction may also take place within the gasification reactor.

The gasification reactor assembly 30 may comprise an indirectly heated rotary kiln. Alternatively, the gasification reactor assembly may comprise a fixed bed gasifier. Alternatively again, the gasification reactor assembly may comprise any other suitable gasifier.

The gasification reactor assembly 30 may comprise one or more burners 34 configured to heat the reactants, e.g. to produce the superheated steam. The burners may be dual/multi-fuel burners, which may be configured to operate using natural gas, e.g. methane and/or propane and/or liquified petroleum gas (LPN) and/or liquified natural gas (LNG), and/or syngas (or a mixture of syngas and hydrocarbons, e.g. volatile hydrocarbons). The burners may be positioned equidistantly along the heated length of the reactor shell to provide the thermal energy required to perform the gasification reactions. Each burner may be independently controlled based on temperatures measured by one or more temperature sensors, e.g. respective temperature sensors, positioned in the gasification reactor assembly, e.g. in a shroud. The burners may be configured to maintain independent temperature set points up to and including 1000 °C This may allow the heated length of the rotary reactor shell to have a desired temperature, or desired temperature profile, for additional operational flexibility.

During a start-up procedure of the system 2, natural gas and/or propane and/or LPN and/or LNG may be supplied from a source external to the system 2, e.g. from the grid, to be burned by the burners of the gasification reactor assembly to heat the reactants. The natural gas may be supplied via a natural gas inlet 38 However, during steady state operation of the system 2, syngas produced through the gasification process may be supplied to the burners, as described below, and may be used to heat the reactants within the gasification reactor vessel.

The gasification reactor assembly 30 may comprise a combustion air inlet 36 for oxygen or air, e.g. atmospheric air, to be supplied to the one or more burners 34. A fan, e.g. a fixed speed fan, may be configured to provide the combustion air required to operate the gasification reactor during both start-up and/or steady state. Nitrogen may be supplied, via a nitrogen inlet 39, to selective purges and seals at the feed and discharge ends of the reactor and ancillaries. Nitrogen may be supplied to the system to reduce a risk of syngas egress to the environment and air ingress to the gasification system.

In addition to syngas, a product of the gasification process may be high-ash carbon residue and/or biochar, which may be removed from the system 2 via a biochar outlet 33. Due to the nature of the gasification process, the biochar may be free from microplastics and/or per-polyfluoroalkyl substances and/or antibiotics. The carbon residue may comprise metals, e.g. soft and heavy metals contained in the original feedstock. In some arrangements, the carbon residue may comprise a majority of the metals present in the original feedstock. In some arrangements, the biochar may be mixed with the liquid separated from the products of the hydrothermal carbonization process.

Syngas output from the gasification reactor may comprise acid gases and/or entrained solids and/or tar and/or oils and/or oil aerosols. The system 2 may further comprise a syngas cleaning unit 40. The syngas cleaning unit 40 may be arranged downstream, e.g. immediately downstream, of the gasification reactor assembly 30 relative to the flow of syngas from the gasification reactor assembly, in order to receive the syngas produce through the gasification reaction.

The syngas cleaning unit 40 may be configured to remove contaminants from the syngas produced by the gasification reactor assembly 30. In particularly, the syngas cleaning unit may be configured to remove entrained solids (e.g. carbon solids), acidic gases, such as hydrogen chloride, hydrogen sulphide, oil and tar. The syngas cleaning unit 40 may comprise a cyclone configured to recover solids/fines entrained in the dirty syngas. The syngas cleaning unit 40 may additionally or alternatively comprise an dry scrubber and/or an aqueous scrubber, such as a venturi quench, cyclonic scrubber, packed bed scrubber and/or wetted wall scrubber, the aqueous scrubber may be configured to remove the tar, and/or oils, and neutralise acid gases present in the dirty syngas. The cyclone and aqueous scrubber may be arranged in series. For example, the dry and/or aqueous scrubber may be arranged downstream of the cyclone. The syngas cleaning unit may comprise a plurality of spray nozzles to increase the contact surface area between the syngas and the circulated water in order to improve the rate of contaminant removal. Additionally or alternatively, the syngas clearing unit may comprise any other devices suitable for removing one or more contaminants from the syngas, such as baffles to promote turbulent gas flow.

The syngas exiting the aqueous scrubber system may be saturated with water. The system may further comprise a condenser 46, for condensing water vapour from the syngas produced by the gasification reactor assembly. As depicted, the condenser 46 may be provided downstream of the syngas cleaning unit 40, relative to the flow of syngas. Water condensed from the syngas by the condenser 46 may be combined with the contaminants removed from the syngas by the syngas cleaning unit 40. In some arrangements, the condenser may be provided as part of the syngas cleaning unit 40. For example, the condenser may be arranged in series with the aqueous scrubber, downstream of the aqueous scrubber.

Water from the aqueous scrubber system may contain unreacted caustic solution and reaction salts from the neutralised acid gases. This stream of water may be stored and treated, before being discharged, e.g. via effluent water outlet 35, to the municipal sewage network. Recovered solids/fines from the cyclone may be added to the high-ash carbon residue from the gasification reactor and/or the dry hydrochar input to the gasification reactor depending on the composition, e.g. average composition, of this material.

The system 2 may comprise a gas supply duct 42 for supplying syngas and/or pyrolysis gas to the burner of the gasification reactor assembly. The gas supply duct 42 may extend from a position downstream of the syngas cleaning unit 40, and optionally downstream of the condenser 46, relative to the flow of syngas/pyrolysis gas, to the burner 34. As described above, during steady state operation of the system 2, the cleaned syngas and/or pyrolysis gas may be burned by the burner 34 in the gasification rector assembly 30 in order to heat the reactants for the gasification process. In this way, fuel for the burner may not be required from a source external to the system when the system 2 is operating in a steady state.

The system 2 may comprise a combustion gas recirculation duct 38 configured to recirculate the products of combustion of the natural gas and/or syngas and/or pyrolysis gas at the burner 34 to a combustion gas heat exchanger 19 provided on the reactor pressure vessel assembly. The combustion gas heat exchanger 19 may be configured to transfer heat from the combustion gases to the reactor pressure vessels 12. After passing through the combustion gas heat exchanger, the combustion gases may be exhausted from the system.

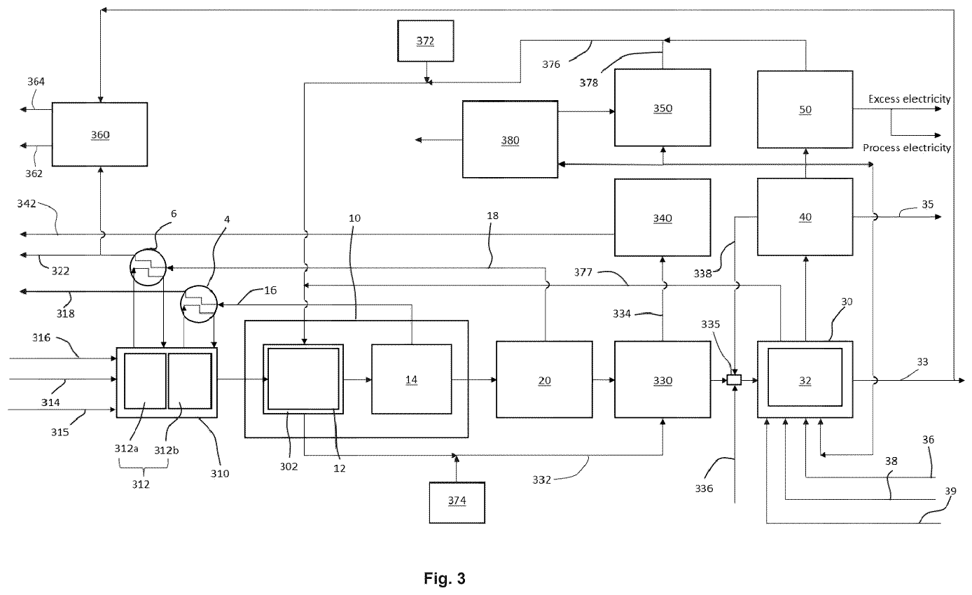

The system 2 may further comprise a contaminant recirculation duct 338 (depicted in FIG. 3) for recirculating at least a portion of the contaminants, such as tar and/or oil, e.g. organic or synthetic derived hydrocarbons optionally including a chain of 5 or more carbon molecules, that have been removed from the syngas in the syngas cleaning unit 40 to the gasification reactor vessel 32 as reactants for the gasification process. Alternatively, the contaminants may be removed from the system.

The system 2 may further comprise an electrical generator 50. The electrical generator may be configured to receive the syngas produced by the gasification reactor assembly 30, e.g. after being cleaned by the syngas cleaning unit 40 and optionally after passing through the condenser 46, and burn the syngas to produce electricity. The electrical generator may be any suitable generator. For example, the electrical generator may comprise a gas turbine for burning the syngas to drive the generator.

In some arrangements, the electrical generator 50 may be electrically connected to the reactor pressure vessel assembly 10, e.g. to the heaters 11 of the reactor pressure vessel assembly 10. During steady state operation of the system, electrical power from the electrical generator 50 may be used to heat the reactants within the reactor pressure vessels 12 to perform the hydrothermal carbonization process of the waste material. In some arrangements, the electricity generated by the gas generators may be used to power other electrical equipment at a plant in which the system 2 is provided.

In some arrangements, an electrical power generated by the electrical generator 50 by consuming, e.g. burning, the syngas produced by the gasification reactor assembly may be greater than an electrical power required for heating the reactor pressure vessels 12 to perform the hydrothermal carbonization process of the waste material. In such arrangements, electrical power may be supplied to an electrical system outside the system 2, e.g. an electrical grid or electrical energy storage system, such as a battery system. Accordingly, the system 2 may comprise an electrical terminal 52 for electrically connecting the electrical generator 50 to an external electrical system.

As described above, during steady state operation of the system, the energy input requirements of the hydrothermal carbonization procedure and the gasification procedure may be met by combusting the syngas and/or pyrolysis gas (or mixture of syngas and hydrocarbons, e.g. volatile hydrocarbons) produced by the system. Accordingly, the system 2 may not require energy from an external source to continue operating in a steady stage and may output energy as excess syngas and/or pyrolysis gas and/or as electricity via the terminal 52 during steady state operation.

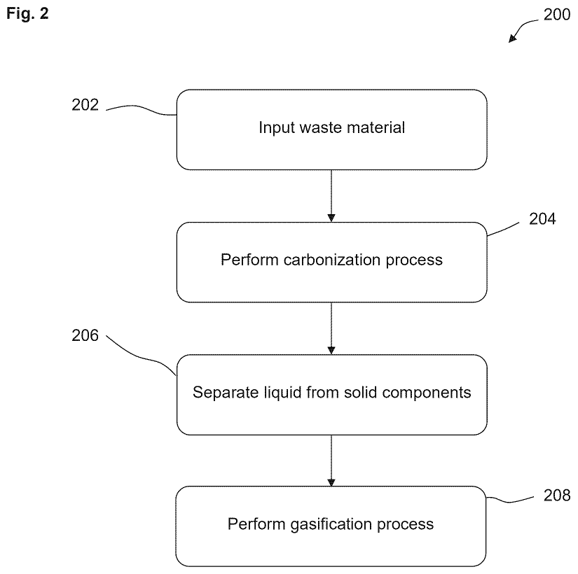

With reference to FIG. 2, a method 200 of processing waste material will now be described. The method may be performed using the system 2 described above. One or more of the steps of the method 200 may be performed sequentially, e.g. during a start-up procedure of the system 2. Alternatively, the steps of the method 300 may be performed substantially simultaneously and continuously, e.g. in a continuous series of batches, during steady state performance of the method 200.

The method comprises a first step 202, in which an input of waste material is received into a reactor pressure vessel, e.g. of the reactor pressure vessel assembly 10. The waste material comprises biosolids and/or biomass, e.g. compliant and/or or non-compliant biosolids, and water. For example, the waste material may comprise primary sludge, and/or secondary sludge, and/or mixed sludge, and/or digestate sludge, and/or activated sludge that has been thickened and/or dewatered to 5-40% solids concentration. The waste material may comprise 10-20% solids.

The method further comprises a second step 204, in which the reactor pressure vessel is heated to perform a hydrothermal carbonization process, e.g. a hydrothermal carbonization process, of the biosolids and/or biomass. In particular, the reactor pressure vessel may be heated to a reaction temperature greater than 160 degrees Celsius, such as between 160 and 260 degrees Celsius, or greater than 170 degrees Celsius or greater than 180 degrees Celsius, such as approximately 200 degrees Celsius, and may reach a reaction pressure of greater than 1.5 MPa, or greater than or equal to 2 MPa, such as between 2 and 2.5 MPa. The reactor pressure vessel may be heated at a rate of between 2 and 5 degrees Celsius per minute for 60 to 90 minutes to reach the reaction temperature. The waste material may be maintained at the reaction temperature and pressure for between 30 minutes and 240 minutes, longer than 3 hours, such as approximately 4 hours, or longer than 4 hours or between 30 minutes and 60 minutes.

The hydrothermal carbonization process may be performed as a continuous series of batch operation process, performed using a plurality of the reactor pressure vessels configured to receive the waste material sequentially.

The hydrothermal carbonization products may comprise 10% or more solids, such as 10-20% solids. In the first example, the hydrothermal carbonization products leave the reactor pressure vessel assembly at a temperature of approximately 100 degrees Celsius or higher.

The method 200 may further comprise discharging the products of the hydrothermal carbonization process, e.g. from the reactor pressure vessel, to one or more expansion vessels, such as the expansion vessels 14 described above, prior to the step of separating the liquid from the solid components. The products of the hydrothermal carbonization process may be at a lower pressure within the expansion vessel than within the reactor pressure vessel.

The method further comprises a third step 206, in which liquid, e.g. water and substances dissolved in the water, is separated from solid components (hydrochar) produced through the hydrothermal carbonization process.

The method further comprises a fourth step 208, in which a gasification process, e.g. a thermal gasification process, such as pyrolysis, is performed on the separated sold components, to produce syngas.

The method 200 may further comprise circulating gases from the expansion vessel, such as water vapour, through a gas heat exchanger, such as the gas heat changer 4, configured to transfer heat from the expansion vessel gases to the input waste material, e.g. prior to the waste material being received in the reactor pressure vessel. The method 200 may further comprise circulating the separated liquid, e.g. from the third step, through a liquid heat exchanger, such as the liquid heat exchanger 6, configured to transfer heat from the separated liquid to the input waste material, e.g. prior to the waste material being received in the reactor pressure vessel. The gas heat exchanger may be arranged downstream of the liquid heat exchanger, relative to the passage of the input waste material to the reactor pressure vessel assembly.

The input waste material may be at ambient temperature before passing through the gas heat exchanger and the liquid heat exchanger and may be at a temperature of up to 80 degrees Celsius when entering the high pressure reactor vessels.

The method 200 may further comprise combusting the syngas produced though the gasification process in a gas powered electrical generator, such as the electrical generator 50, to generate electricity. The electricity generated by the electrical generator may be used to power a heater for the reactor pressure vessel, e.g. during steady state performance of the method. The method may further comprise providing electricity from a source separate from the electrical generator to heat the reactor pressure vessel during a start-up procedure.

The method may further comprise providing combustible gas, such as natural gas and/or propane and/or LPN and/or LNG, from a source separate from the gasification reactor as an input to the gasification process during a start-up procedure of the method of processing waste material. The combustible gas may be combusted, e.g. at the burner 54 of the gasification reactor assembly 30, in order to heat the reactants of the gasification process during the start-up procedure for the method of processing waste material.

The method may further comprise delivering a portion of the produced syngas and/or pyrolysis gas as an input to the gasification process. The portion of the produced syngas may be combusted, e.g. by the burner 34 of the gasification reactor assembly, in order to heat the reactants of the gasification process. During steady state operation of the method, the combustible gas may no longer provided as an input to the gasification process, e.g. once the syngas is available to be combusted for heating the reactants.

The method 200 may further comprise recirculating the combustion gases, produced from the combustion at the burner for heating the reactants of the gasification process, to heat the input waste material upstream and/or within the reactor pressure vessels of the reactor pressure assembly.

During steady state performance of the method, the waste material within the reactor pressure vessels may be heated using any combination of the gas heat exchanger/steam condenser, the liquid heat exchanger, the recirculated combustion gases resulting from the combustion at the burner and/or the combustion gases from the gas generator for heating the reactants of the gasification process, e.g. circulated through one or more jackets arranged about the reactor pressure vessels, e.g. respectively, and/or using heaters, e.g. electrical heaters 11, provided in the reactor pressure vessel assembly. As described above, the heaters 11 may be powered using electrical power generated by the electrical generator 50.

However, during the start up procedure of the method, the heat may be supplied to the reactor pressure vessel using the heater of the reactor pressure vessel assembly only. The method may further comprise cleaning the syngas produced through the gasification process, in order to remove contaminants from the syngas and/or pyrolysis gas. The syngas may be cleaned prior to the syngas being used for other purposes as part of the method of processing waste. In particular, the syngas may be cleaned prior to being combusted by the gas generator to produce electricity and/or supplied to the burner of the gasification reactor assembly. The syngas may be cleaned using the syngas cleaning unit described above. The method may further comprise recirculating at least a portion of the contaminants removed from the syngas as an input to the gasification process.

Additionally or alternatively, the method may comprise passing the syngas and/or pyrolysis gas through a condenser to remove water vapour from the syngas, e.g. prior to the syngas being used for other purposes as part of the method. The syngas may be passed through the condenser after contaminants are removed.

With reference to FIG. 3, a system 300 for processing waste material, according to another arrangement of the disclosure, will now be described. The system 300 may be similar to the system 2 described above with reference to FIG. 1 and may comprise the system 2. Features described above in relation to the system 2 may apply equally to the system 300 and vice versa. In particular features described below in relation to the system 300 may be provided as part of the system 2. The system 300 may be for processing waste material comprising biomass and/or biosolids. For example, human and/or animal digestive waste and/or plant derived waste that may or may not have gone through anaerobic and/or aerobic digestion. The system 300 comprises the reactor pressure vessel assembly 10, comprising the one or more reactor pressure vessels 12 and the one or more expansion vessels. The system 300 further comprises the separating unit 20 and the gasification reactor assembly 30. Additionally, the system 300 may further comprise the syngas cleaning unit 40 and/or the electrical generator 50.

The system 300 differs from the system 2 in that the reactor pressure vessel assembly comprises jackets 302 arranged about the reactor pressure vessels 12 for circulating combustion gases around the reactor pressure vessels in order to heat the reactants within the reactor pressure vessels. The system may comprise one or more first natural gas/propane burners 372 configured to burn natural gas and/or propane and/or LPN and/or LNG and produce hot combustion gases for circulating through the jackets. During start-up of the system 300, the first natural gas/propane burners 372 may be operated to heat the reactor pressure vessels. In this case, further heaters, such as the electric heaters described above with reference to FIG. 1 may be omitted.

The jackets 302 may be configured to receive combustion gases from the gasification reactor 32 and/or the electric generator 50. During steady state operation of the system 300, the reactor pressure vessels may be heated by, e.g. exclusively by, the heat of the combustion gases from the gasification reactor and/or the electric generator 50. As depicted, the system 300 may comprise an electrical generator combustion gas duct 376 for carrying combustion gases from the electrical generator 50 to the jackets 302. In such arrangements, the first natural gas/propane burners 372 may not be operated during steady state operation of the system 300.

The or each reactor pressure vessel 12 may be rotated, e.g. about an axis with a vertical component, such as a vertical axis, using an electric or hydraulic motor. This may ensure that the hot combustion gas is evenly distributed across the surface area of each vessel. The or each reactor pressure vessel may contain internal baffles to assist with mixing/disturbing the feedstock while rotating to promote even heat transfer and limit fouling.

The system 300 further comprises a feedstock preparation unit 310. The waste material input to the system 300 may be received at the feedstock preparation unit prior to be fed to the reactor pressure vessels 12. The feedstock preparation unit 310 may comprise one or more feedstock holding tanks 312. In the arrangement depicted in FIG. 3, the feedstock preparation unit 310 comprise two feedstock holding units.

The feedstock preparation unit is configured to ensure that the feedstock is fed to the reactor pressure vessels at or within desired input ranges of solids concentration and/or temperature.

Feedstock (comprising biosolids) may be received at the feedstock preparation unit, e.g. from a traditional wastewater treatment plant, via a first waste input 314. The feedstock may be received into a first feedstock holding tank 312a of the feedstock preparation unit. The feedstock received via the first waste input 314 may have a solids concentration between 5 and 40%. A desired input range of feedstock solids concentration to the reactor pressure vessel may be between 10 and 20%. Dilute wastewater (treated or untreated), e.g. from a wastewater treatment plant, may be received at the feedstock preparation unit 310 via a second waste input 316. The feedstock preparation unit may be configured to mix the dilute wastewater received from the second waste input 316 with the feedstock received via the first waste input 314.

The system 300 may further comprise an organic waste input 315 for organic waste, such as organic waste comprising a high concentration of one or more of cellulose, lignocellulose, and/or lignin compounds. For example, the organic waste may comprise chicken manure, olive pomace, wheat husks, shredded biomass, etc. The co-processed waste biomass may contain between 1-100% solids concentration. The remaining fraction may be predominantly water. The organic waste may be provided as an input to the feedstock preparation unit together with the waste material and optionally the dilute wastewater. Accordingly, the organic waste may be provided as an input to the reactor pressure vessels, e.g. together with the waste material and waste water.

The presence of the organic waste within the feedstock may improve fixing of the soft and heavy metals present in the biosolids with the solid carbon present in the organic waste during the hydrothermal carbonization process. Additionally or alternatively, the heavy metals and solid carbon may be forged together under the high temperature conditions in the gasification reactor to form a non-leachable mineral matrix, i.e. high-ash carbon residue, which may improve absorption of compounds within the nutrient-rich process water, as described below.

The feedstock slurry in the first feedstock holding tank 312a may be pumped through the liquid heat exchanger 6, e.g. to receive heat from the nutrient-rich process water. The heat from the nutrient-rich process waste may be received at a temperature of 20-80 °C. The feedstock slurry in the first feedstock holding tank 312a may be pumped through the liquid heat exchanger to a second feedstock holding tank 312b. The feedstock slurry in the second feedstock holding tank may be pumped through the gas heat exchanger 4, e.g. to receive latent heat from the gases from the expansion vessel 14, such as steam. The feedstock slurry that is pumped through the gas heat exchanger may be returned to the second feedstock holding tank before being supplied to the reactor pressure vessels. The desired input temperature range for the waste material to be fed to the reactor pressure vessels, e.g. for the hydrothermal carbonisation process may be between 15 and 100 °C

In the gas heat exchanger 4, the steam may be condensed to potable water, which may be output from the system via potable water output 318. The nutrient-rich process water that has passed though the liquid heat exchanger 4 may be diverted to a product mixing/absorption unit 360 (described in greater detail below) and/or or output as a nutrient-rich process water output 322. The nutrient-rich process water can either be used as a fast-release nutrient liquid fertiliser product or fed to an anaerobic digestor for biogas production and carbonaceous oxygen demand reduction prior to discharging the ‘cleaned’water to the environment.

The system 300 may further comprise a dryer unit 330 configured to remove entrained moisture from the wet hydrochar using, for example, a convective drying method to produce dry hydrochar with a predetermined moisture content. The wet hydrochar that is output from the separation unit 14 may be fed to the dryer unit via a screw conveyor. The dryer unit 330 may comprise a direct rotary dryer. Hot combustion gases from the jackets 302 of the high pressure reactor vessels, e.g. which has been circulated through the jackets, may be diverted via a combustion gas dryer duct 332 to the dryer unit 330. The combustion gases may be passed through the dryer unit in either the co-current or counter-current direction to the wet hydrochar feed. The dryer unit may contain internal lifters configured to lift the hydrochar solid within the dryer to mix the solids with the hot combustion gas. The hydrochar may be dried to a solid concentration of at least 90% solids and output from the dryer unit to the gasifier. The wet combustion gas may exit the dryer unit carrying entrained steam via a wet combustion gas duct 334.

The system 300 may further comprise a dryer off-gas cleanup unit 340. The dryer off-gas cleanup unit may receive the wet combustion gases from the dryer unit via the duct 334. The wet combustion gases may be received by the dryer off-gas cleanup unit at a temperature above their dew point temperature in order to avoid condensation. The dryer off-gas cleanup unit may be configured to remove and recover solid hydrochar entrained in the wet combustion gases that have been used to dry the wet hydrochar. The dryer off-gas cleanup unit may comprise a cyclone or bag filter for removing the solid hydrochar. The wet combustion gas may then be output from the system 300 via a wet combustion get outlet 342.

The system 300 may further comprise a Shredded (comminuted) non-biodegradable waste input 336. The comminuted non-biodegradable waste may also referred to as ‘shredded screening'. Feedstock of shredded screening may be fed to the gasification reaction 30, e.g. if available from the wastewater treatment plant. The shredded screening may comprise any combination of inorganic (non-metallic) waste materials including plastics (PP, HDPE, LDPE, PVC, PS, PET, and other plastics), synthetic rubbers (domestic cleaning gloves, 'medical-grade’ gloves, other rubbers), and/or various synthetic household waste materials (wet-wipes, sanitary materials, cleaning materials, etc.). The shredded screenings may be added to the dried hydrochar and mixed thoroughly to uniformly distribute the shredded material within the hydrochar before being fed to the gasification reactor.

Additionally or alternatively, as described above, tar and/or oils collected by the syngas cleaner 40 can be recycled to the gasification reactor as an optional feedstock and method of carbon recovery. The tar and/or oils could be added to the dried hydrochar, e.g. in addition to or as an alternative to the shredded screening and mixed, e.g. thoroughly mixed, to uniformly distribute the material within the hydrochar before being fed to the gasification reactor. The tar and/or oils may be fed to the gasification reactor via the contaminant recirculation duct 338.

The system 300 may further comprise a gasification feedstock mixing unit 335 configured to mix, e.g. homogenously mix, the hydrochar and/or tar and/or oils collected by the syngas cleaner and/or shredded screenings. For example, the gasification feedstock mixing unit 335 may comprise a high sheer mixing screw positioned within a mixing trough.

The system 300 may further comprise a ground flare unit 350. During start up and shut down of the system 300, the syngas produced by the gasification process may be out of specification and incompatible with operating the electrical generator 50. Additionally, during start-up hot combustion gases may be required for heating the high pressure reaction vessels and for drying the wet hydrochar. The ground flare unit 350 may be configured to receive syngas from the cleaning unit, e.g. during start-up and/or shutdown of the system and react the syngas with oxygen to produce hot combustion gases, which may be conducted to the high pressure reactor vessels, e.g. the jackets 302, via a ground flare combustion gas duct 378.

During steady state operation of the system, the syngas, e.g. all of the syngas, from the cleaning unit 40 may be delivered to the electrical generator 50, and the ground flare unit 350 may be maintained in a standby mode with a pilot flame. The hydrothermal carbonisation and convective drying steps may then be operated using waste heat from the gasification reactor and electrical generator in the form of hot combustion gas. However, when, for example, the ambient temperature is very low and heat is lost to the environment from the interconnecting pipework, the hot combustion gas diverted to the hydrothermal carbonisation and convective drying steps can be supplemented with the hot combustion gas from the ground flare unit 350, e.g. if desired.

The system 300 may further comprise a hydrogen separation unit 380. The hydrogen separation unit may be configured to receive the cleaned syngas from the cleaning unit 40 and separate and concentrate hydrogen gas present in the cleaned syngas. In particular, the hydrogen separation unit may be configured to use pressure swing adsorption and/or membrane technologies in order to separate and concentrate the hydrogen. The composition and water content of the dried hydrochar feedstock delivered to the gasifier may influence the concentration of hydrogen in the syngas. In arrangements in which hydrogen gas is a desirable product from the system 300, the hydrogen separation unit may be operated to separate and purify the hydrogen from the remaining volatile organic compounds in the cleaned syngas. The remaining syngas following separation of the hydrogen may be rich in carbon monoxide, volatile hydrocarbons and volatile organic compounds and may have a high-calorific value. The remaining syngas may be provided to the ground flare unit 350 and/or the electrical generator 50.

The system 300 may further comprise a mixing/absorption tank 360. The mixing/absorption tank may be configured to receive the nutrient-rich process water that has passed though the liquid heat exchanger 4 and at least a portion of the solid product output from the gasification reactor. Mixing these two streams may product a slow nutrient-release solid fertilizer product for the agricultural market, output from the cleaning/mixing tank via slow nutrient-release solid fertilizer outlet 362.

Furthermore, the high surface area of the carbon residue can be used to capture and store the phosphate and ammonium ions contained in the nutrient-rich process water to release these nutrients to the soil at a slower rate compared to the liquid fertiliser. As mentioned above, inclusion of the organic/biomass waste within the feedstock to the hydrothermal carbonisation process may lead to the production of a caron residue with improved adsorption properties. In particular, high surface area of the mesopores present in the high-ash carbon residue improve retention by ammonium ions present in the nutrient-rich carbon residue during the Adsorption step. This may limit the runoff of these nutrients and the potential contamination of shallow ground water aquifers. The filtered process water which remains may be anaerobically digested for biogas production and carbonaceous oxygen demand reduction prior to discharging the ‘cleaned’water to the environment, e.g. via waste outlet 364.

The system 300 may further comprise a second natural gas/propane burner 374. During a start-up procedure of the system 300, the second natural gas/propane burner may be configured to burn natural gas and/or propane and deliver hot combustion gases to the dryer unit 330 to dry the wet hydrochar within the dryer unit. During steady state operation and/or when there is sufficient thermal energy in the hot combustion gas that are output from the jackets 302 around the high pressure reaction vessels 12 to the dryer unit to dry the hydrochar to a desired percentage of solids, e.g. by mass, the second natural gas/propane burner 374 may be switched off to no longer burn natural gas and/or propane.

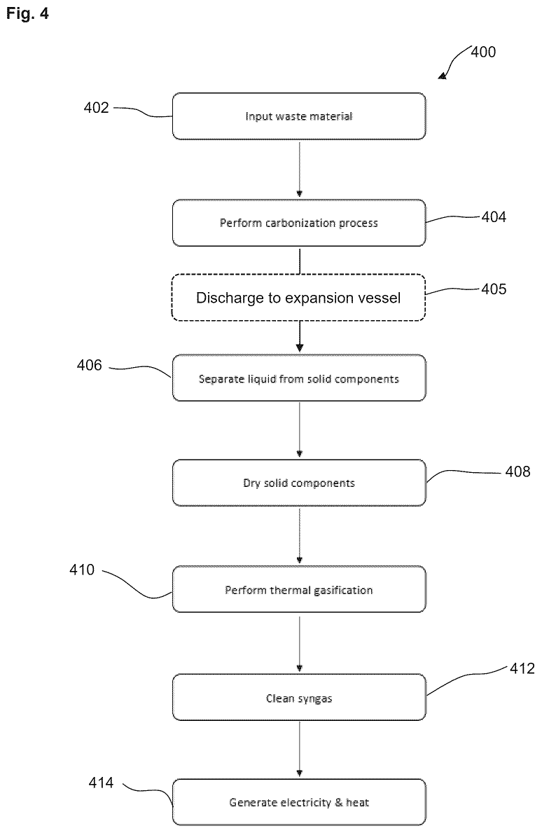

With reference to FIG. 4, a method 400 of processing waste material will now be described. The method may be performed using the system 300 described above. The method 400 may be similar to the method 200 described above and may comprise the method 200. Features described in relation to the method 200 may apply equally to the method 400 and vice versa. One or more of the steps of the method 400 may be performed sequentially, e.g. during a start-up procedure of the system 2. Alternatively, the steps of the method 400 may be performed substantially simultaneously and continuously, e.g. in a continuous series of batches, during steady state performance of the method 400.

The method comprises a first step 402, in which an input of waste material is received into a reactor pressure vessel, e.g. of the reactor pressure vessel assembly 10. The waste material comprises biosolids and/or biomass, and water. For example, the waste material may comprise primary sludge, and/or secondary sludge, and/or mixed sludge, and/or digestate sludge, and/or activated sludge that has been thickened and/or dewatered to 5-40% solids concentration The method further comprises a second step 404, in which the reactor pressure vessel is heated to perform a hydrothermal carbonization process, e.g. a hydrothermal carbonization process, of the biomass.

The method 400 may comprise an expansion step 405, in which the products of the hydrothermal carbonisation process are discharged into expansion vessels, e.g. the expansion vessels 14, at a lower pressure than within the reactor pressure vessels in which the hydrothermal carbonization process is performed, e.g. at atmospheric pressure. As described above, the reduction in pressure, e.g. rapid reduction in pressure, of the hydrothermal carbonization products within the one or more expander vessels may lead to rupturing of the structure of the solid components of the products, which may in turn release further amounts of nitrogen, phosphorous, potassium (and nitrogen, phosphorous and potassium containing compounds) and organic substances from the solids, e.g. into the liquid and/or gaseous phase of the products. Additionally, discharging the products of the hydrothermal carbonization process into the expansion vessels 14 may cause any bacteria, e.g. pathogenic bacteria, present in the products to rupture. The products of the hydrothermal carbonization process within the expansion vessel may therefore be sterile. Additionally again, discharging the products to the expansion vessel 14 may cause up to 20% (by mass) of water in the hydrochar slurry to converted, e.g. substantially instantaneously, to steam. The expansion step 405 may comprise removing the steam released from the products.

The method further comprises a third step 406, in which liquid, e.g. water and substances dissolved in the water, is separated from solid components (hydrochar) produced through the hydrothermal carbonization process, e.g. by a separation unit, such as the separation unit 14 described above.

The method further comprises a drying step 408, in which the separated solids are dried, e.g. using the drying unit 330, so that a percentage of solids (by mass) is at a desired percentage for input to a gasification process. The separated solids may be dried using a convective drying process, e.g. by circulating hot combustion gases though the dryer unit.

The method further comprises a fourth step 410, in which a gasification process, e.g. a thermal gasification process, such as pyrolysis, is performed on the separated sold components, to produce syngas.

The method may further comprise a fifth step 412, in which the syngas produced through the gasification processes is cleaned, e.g. using the syngas cleaning unit 40, so that the syngas is suitable for use in an electrical generator, such as the electrical generator 50. For example, in the fifth step the dirty syngas may be passed through a cyclone or other device for removing entrained solids form the syngas and/or through an aqueous or dry scrubber for removing acid gases, oil and/or tar from the syngas. In the fifth step 412, the syngas, e.g. which has passed through the aqueous scrubber, may be passed through a condenser to remove moisture from the syngas.

The method 400 may further comprise a sixth step, in which the cleaned syngas is used, e.g. combusted, to generate electricity, e.g. by the electrical generator 50.

It will be appreciated by those skilled in the art that although the invention has been described by way of example, with reference to one or more exemplary examples, it is not limited to the disclosed examples and that alternative examples could be constructed without departing from the scope of the invention as defined by the appended claims.

1. A method of processing waste material, wherein the waste material comprises human and/or animal digestive waste and/or plant derived waste, wherein the method comprises:
receiving an input of waste material into a reactor pressure vessel;
heating and pressurizing the reactor pressure vessel to perform a hydrothermal carbonization process of the waste material;
separating at least a portion of a liquid from solid components of the products produced through the hydrothermal carbonization process;
performing a gasification and/or pyrolysis process on the solid components, to produce syngas and/or pyrolysis gas.

2. The method of claim 1, wherein the waste material comprises a primary sludge, and/or secondary sludge, and/or mixed sludge, and/or digestate sludge, and/or activated sludge that has been thickened and/or dewatered to 5-40% solids concentration e.g., produced through anaerobic and/or aerobic digestion of human and/or animal digestive waste and/or plant derived waste.

3-4. (canceled)

5. The method of claim 1, wherein reaction temperature and pressure of the reactants within the reactor pressure vessel are maintained to achieve subcritical conditions for water within the reactor pressure vessel.

6. (canceled)

7. The method of claim 1, wherein the hydrothermal carbonization process is performed as a continuous series of batch operation process, performed using a plurality of the reactor pressure vessels configured to receive the waste material sequentially and performed the hydrothermal carbonization process at time period offset from one another by less than a total duration of the hydrothermal carbonization process.

8. The method of claim 1, wherein the method further comprises:
discharging the products of the hydrothermal carbonization process to an expansion vessel at a lower pressure than the reactor pressure vessel prior to the step of separating the liquid from the solid components.

9. The method of claim 8, wherein the method comprises:
circulating gases from the expansion vessel through a gas heat exchanger configured to transfer heat from the expansion vessel gases to the input waste material prior to the waste material being received in the reactor pressure vessel.

10. The method of claim 1, wherein the method comprises:
circulating the separated liquid through a liquid heat exchanger configured to transfer heat from the separated liquid to the input waste material prior to the waste material being received in the reactor pressure vessel.

11-15. (canceled)

16. The method of claim 1, wherein the method comprises drying the separated solid components to a target moisture content using a connective drying process, wherein drying the separated solid component comprises feeding combustion gases, from a gas generator and/or a burner, over the separated solid components.

17. The method of claim 16, wherein the method further comprises combusting the syngas and/or pyrolysis gas produced through the gasification and/or pyrolysis process in a gas generator to generate electricity, and wherein the electricity generated by the gas generators is used to power a heater for the reactor pressure vessel.

18. (canceled)

19. The method of claim 1, wherein the method comprises circulating combustion gases, from a gas generator or a burner; around the reactor pressure vessel to heat the reactor pressure vessel and perform the hydrothermal carbonization process.

20-23. (canceled)

24. The method of an wherein the method further comprises:
delivering a portion of the produced syngas as an input to the gasification process, wherein the portion of the produced syngas is combusted in order to heat the reactants of the gasification process; and
circulating the combustion gases resulting from the combustion for heating the reactants of the gasification process to heat the input waste material upstream and/or within the reactor pressure vessel.

25. The method of claim 1, wherein the method further comprises:
cleaning the syngas produced through the gasification process prior to the syngas being used for other purposed as part of the method of processing waste, in order to remove contaminants from the syngas; and
recirculating at least a portion of the contaminants removed from the syngas as an input to the gasification process.

26-27. (canceled)

28. A system for processing waste material, wherein the waste material comprises human and/or animal digestive waste and/or plant derived waste, wherein the system comprises:
a reactor pressure vessel assembly comprising one or more reactor pressure vessels for receiving an input of waste material and heating and pressurizing the waste material within the vessels to perform a hydrothermal carbonization process of the waste material;
a separating unit, for separating liquid from solid components produced though the hydrothermal carbonization process; and
a gasification reactor vessel for receiving the solid components and performing a gasification and/or pyrolysis process on the separated solids within the gasification reactor vessel to produce syngas and/or pyrolysis gas.

29. The system of claim 28, wherein the reactor pressure vessel assembly further comprises one or more expansion vessels for receiving the products of the hydrothermal carbonization process from the one or more reactor pressure vessels at a lower pressure than the reactor pressure vessels.

30. The system of claim 29, wherein the system further comprises:
a gas heat exchanger/steam condenser, configured to receive gases, e.g., steam, from the one or more expansion vessels and transfer heat from the gases to the input waste material.

31. The system of claim 28, wherein the system further comprises:
a liquid heat exchanger, configured to receive the liquid separated by the separating unit and transfer heat from the liquid to the input waste material.

32. The system of claim 31, further comprising a gas heat exchanger/steam condenser, configured to receive gases, e.g., steam, from the one or more expansion vessels and transfer heat from the gases to the input waste material, wherein the reactor pressure vessel assembly further comprises one or more expansion vessels for receiving the products of the hydrothermal carbonization process from the one or more reactor pressure vessels at a lower pressure than the reactor pressure vessels, and wherein the gas heat exchanger is arranged downstream of the liquid heat exchanger, relative to the passage of the input waste material to the reactor pressure vessel assembly.

33-39. (canceled)

40. The system of claim 28, wherein the reactor pressure vessel assembly comprises a plurality of reactor pressure vessels and one or more expansion vessels, wherein the reactor pressure vessels are configured to store reactants and products at a higher pressure than the expansion vessels, wherein the expansion vessels are configured to receive products of the reaction within the respective reactor pressure vessels, wherein the reactor pressure vessel assembly is configured to operate in a continuous series of batch procedures in which reactants are input to the plurality of reactor pressure vessels sequentially, products of the reactions within the reactor pressure vessels are output to expansion vessels sequentially, and the hydrothermal carbonization process is conducted over staggered time periods within the sequential reactor pressure vessels.

41. (canceled)

42. The system of claim 40, wherein the reactor pressure vessel assembly further comprises one or more ducts for conducting gases from the expansion vessels to one or more heat exchangers for heating reactants input to respective ones of the reactor pressure vessels, wherein the ducts arranged so that that gases from the expansion vessels are conducted to the heat exchange configured to heat the reactant within the next of the reactor pressure vessels to receive reactants in the continuous series of batch procedures.

43-45. (canceled)

46. The system of claim 28, wherein System further comprises:
a gas generator for using the syngas produced by the gasification reactor to produce electricity, wherein the system comprises an electrical generator combustion gas duct configured to conduct combustion gases from the gas generator to the reactor pressure vessel assembly for heating the reactor pressure vessel assembly.

47. (canceled)
